(19) United States
(12) Patent Application Publication
(10) Pub. No.: US 2008/0071659 A1
(43) Pub. Date: Mar. 20, 2008

(54) Method for exchanging option contracts using a central counterparty

(76) Inventors: J. Scott Perry, New York, NY (US); Wallace C. Turbeville, New York, NY (US)

Correspondence Address: AUFRICHTIG & AUFRICHTIG, P.C., 300 EAST 42ND STREET, 5th Floor, NEW YORK, NY, 10017, US

(21) Appl. No.: 11/903,252

(22) Filed: Sep. 20, 2007

Related U.S. Application Data
(60) Provisional application No. 60/845,855, filed on Sep. 20, 2006.

(51) Int. Cl. G06Q 40/00

(52) U.S. Cl. 705/35

(57) ABSTRACT

A method of contracting between two counterparties with a central counterparty for the exchange of payments based upon pairs of contracts. The payouts are based on the output of a pricing model in which the model output is calculated periodically, and the payments are exchanged periodically through transfers by the central counterparty. The period of calculation and payment occurs each business day. The model is driven by (i) an index indicating the price of a commodity; (ii) the volatility of the index; (iii) a nominal strike price; (iv) time to expiration; and (v) risk free interest rate, and (vi) other variables.

### CROSS-REFERENCE TO RELATED APPLICATIONS

This application claims the priority of provisional application Ser. No. 60/845,855 filed in the United States Patent and Trademark Office on Sep. 20, 2006.

### BACKGROUND OF THE INVENTION

Power and Gas traders frequently trade options on gas and electricity bilaterally. These options are generally delivery options, giving the holder of a call the option to take delivery of power or gas at a predetermined strike price from the writer of the option, and the holder of a put option the right to sell at a predetermined strike price. At expiration, the economics of owning or writing a call or put option are shown in FIGS. 1 and 2.

The buyer of an option is said to be ‘long’; the writer is said to be ‘short’. The financial outcome for the party which is ‘long’ a call are the same as that of a fixed payor party to a fixed to floating price swap with a floor on the floating price; the returns of written ‘short’ call are similar to those of a fixed receiver party to a fixed to floating swap with a floor on the floating price.

Similarly the return of a ‘long’ put are the same as those of a fixed receiver party to a fixed to floating swap with a cap on the floating price, and the return of a ‘short’ put are those of a fixed payor party to a fixed to floating swap with a cap on the floating price.

Options for physical delivery of a commodity are often used as hedges to fix the cost of the commodity at specific locations. FIGS. 3 and 4 show graphs of the general use of a call option on Power. A load serving entity buys a call option to hedge its cost of power, and a generation company sells the call to generate income, taking advantage of optionality inherent in his asset mix.

In this case, a Generation Company (GenCo) has increasing income as spot prices rise. If its fuel costs are hedged at a certain level, it may be happy to fix its upside at an established profit. By writing a swap he can establish this fixed margin, thereby capping his potential profits, and book as income the price of the option. If the spot price falls below a certain level (say the strike price), there is no requirement that he generate power; it is unlikely that the call holder would call on the power at the strike price, as the spot price is lower. In any case he could buy in the spot market to cover his generation requirement.

Physical energy options allow the holder of a call (or put) to purchase (or sell) physical power to (or from) the option writer, at the strike price. Exercise may involve a daily decision to sell or buy energy, usually based on the spot price for the product on the day the option is exercised.

An option on a swap (a “Swaption”) does not entail delivery, but is an option to enter into a financial fixed payor or fixed receiver swap contract by a certain date and at a certain fixed price. This product allows the holder of a call to capture the rise (or fall) in the swap index (times the notional quantity of swap contract) to hedge his exposure in the spot market. The value of options on physical contracts and swaps may be estimated prior to exercise using a variety of option pricing models (including a Black-Scholes model, Black '76 model, Cox Rubenstein model etc.)

Capped/Floored swaps are not options to buy or sell any asset, but are simply swaps which have limitations on how high (or low) the floating index is allowed to ‘float’. A swap with a floor (or cap) has the same economic outcome of a call (or put) option at expiration.

In the Bilateral Trading of Options, in-the-money (ITM) value on an option with one counterparty can not be used as collateral to cover out-of-the-money (OTM) exposure to another counterparty (in the absence of re-hypothecation agreements). Capital allocation to Bilateral Option Trading would be greatly reduced if these marks to market could be netted across all counterparties and products.

There is a need to offer financial products which produce the same economics as options, and it is proposed that this be achieved via swaps which settle across all pricing conditions as thought they were options or capped/floored swaps. Therefore, fixed to floating swaps with floors or caps can be used to achieve the economics of options at expiration.

### SUMMARY OF THE INVENTION

The present invention relates to a method of clearing the marked value of different types of option contracts via a central counterparty.

An object of the invention is to determine the contractual exchange of returns by an option pricing model, Option Model Swaps (OM Swaps). An OM Call swap is a swap of payments based on the output of a call valuation model; an OM Put swap is a swap of payments based on the output of a put valuation model.

Another object of the present invention is to provide swaps based on a modified Black '76 model and an agreed upon price index. The Black '76 model is simply a Black-Scholes model swap designed to recognize the lack of carrying cost for an option on a futures contract or swap contract.

A further object of the present invention is to provide an option on a swap by giving the fixed payor of the OM swap (call or put) the option of entering into a swap at market with the fixed receiver of the OM Swap.

Yet another object of the present invention is to provide an option on a physical by giving the fixed payor of the OM swap (call or put) the option of entering into a physical swap at market; the Physical swap is accompanied by a bilateral indexed physical delivery contract.

A further object of the present invention is to provide an option on index by amortizing OM Swaps, which settle daily quantities against the model output driven by the daily index, and remaining forward quantities settled against the model output driven by a forward index.

Still a further object of the present invention is to provide daily cash settlements and netting to allow holders of OM Swaps to net payments which would otherwise be trapped in bilateral collateral positions.

The invention accordingly comprises the features of construction, combinations of elements and arrangements of parts which will be exemplified in the construction as hereinafter set forth, and the scope of the invention will be indicated in the Claims.

### BRIEF DESCRIPTION OF THE DRAWINGS

For a fuller understanding of the invention, reference is made to the following description taken in connection with the accompanying drawings, in which:

FIG. 1 is a graph showing the basic economics of a Call Option;

FIG. 2 is a graph showing the basic economics of a Put Option;

FIG. 3 is a graph showing use of a ‘Long’ Call to lock a price on the upside in exchange for paying the option price;

FIG. 4 is a graph showing how to generate income in exchange for capping profits;

FIG. 5 is a graph showing use of ‘Short’ Put to generate income and fix price on downside;

FIG. 6 is a graph showing use of ‘Long’ Put to lock in income on downside, in exchange for paying the price of the option;

FIG. 7 is a graph showing VMAC OM Swap Returns;

FIG. 8 is a graph showing VMAC OM Swaps;

FIG. 9(a) is a diagram of the traditional Bilateral Swap;

FIG. 9(b) is a diagram of the netting benefits of VMAC OM Swaps

FIG. 10 is a graph showing the daily cash settlements with floor on floating price;

FIG. 11 is a graph showing the daily cash settlements with cap on floating price;

FIG. 12(a) is a diagram showing termination of non-defaulting party to balance book using collateral;

FIG. 12(b) is a diagram showing termination of non-defaulting party in the traditional Bilateral Option Market;

FIG. 13 is a diagram showing the re-pairing rules for VMAC OM Call Swap;

FIG. 14(a) is a diagram showing the re-pairing rules for VMAC OM Put Swap;

FIG. 14(b) is a diagram showing a scenario where a counterparty C in FIG. 14(a) has its strike changed;

FIG. 15(a) shows a diagram of an example of re-pairing with the same index changing counterparty C's price;

FIG. 15(b) shows a diagram of an example of re-pairing with the same index changing counterparty A's price;

FIG. 16 is a graph showing correlating index swaps with VMAC OM Swaps;

FIG. 17 is a graph showing the return of a VMAC Option Model Call Swap over time with a fixed index value; and

FIG. 18 is a graph showing the return of a VMAC Option Model Call Swap at a time t, given a changed in index.

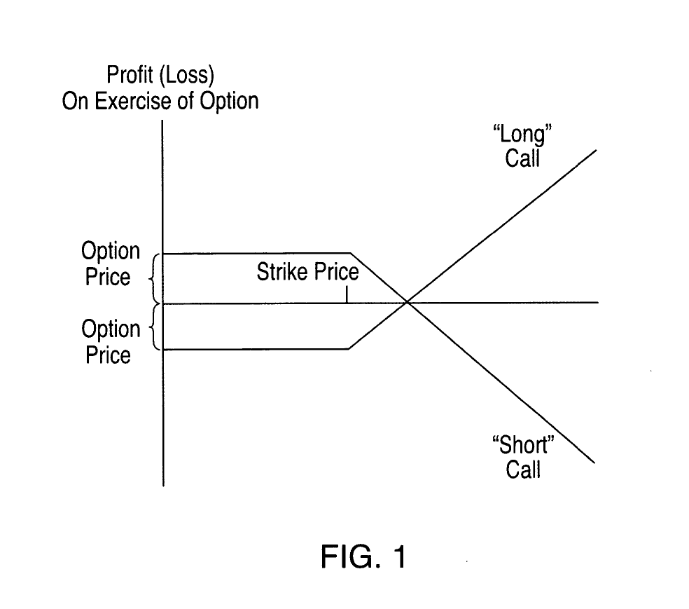

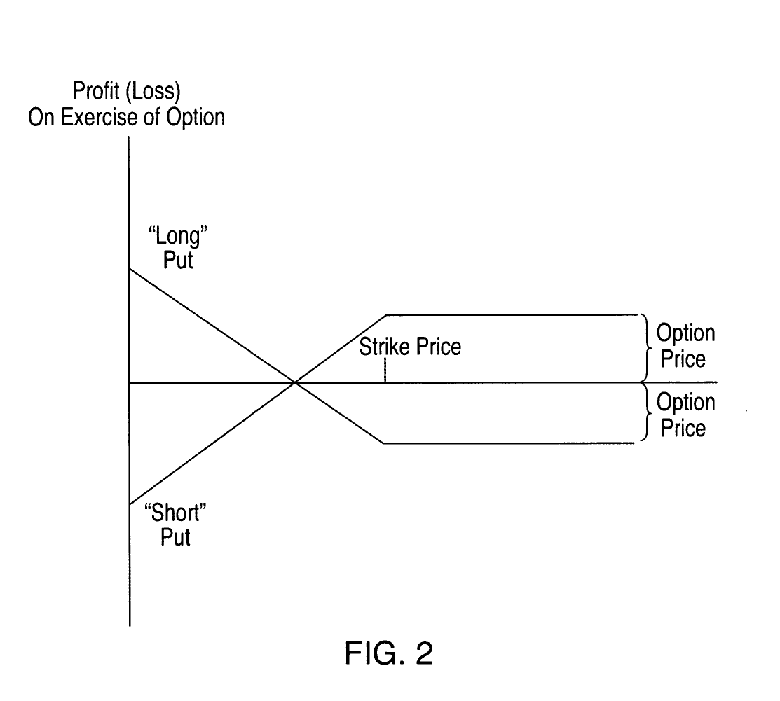

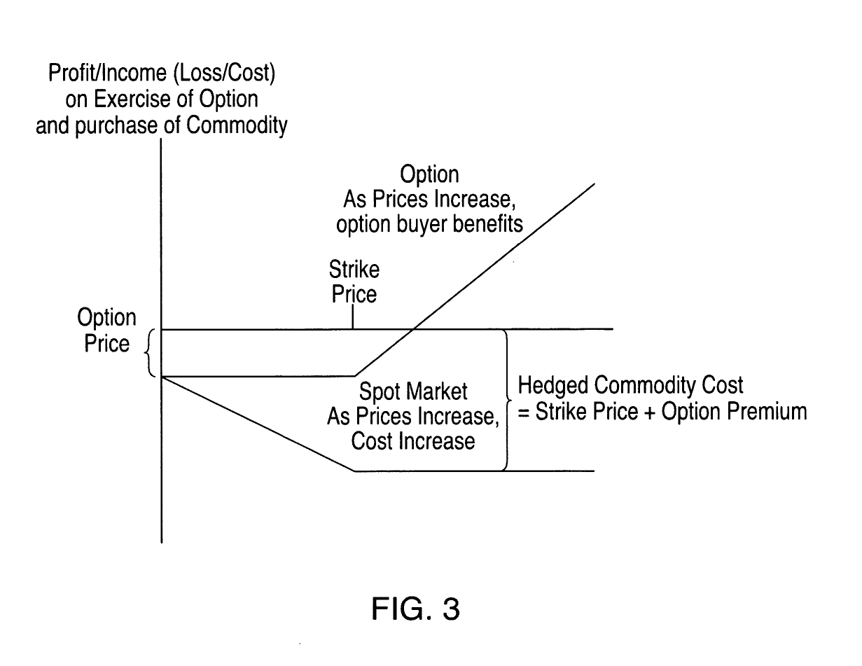

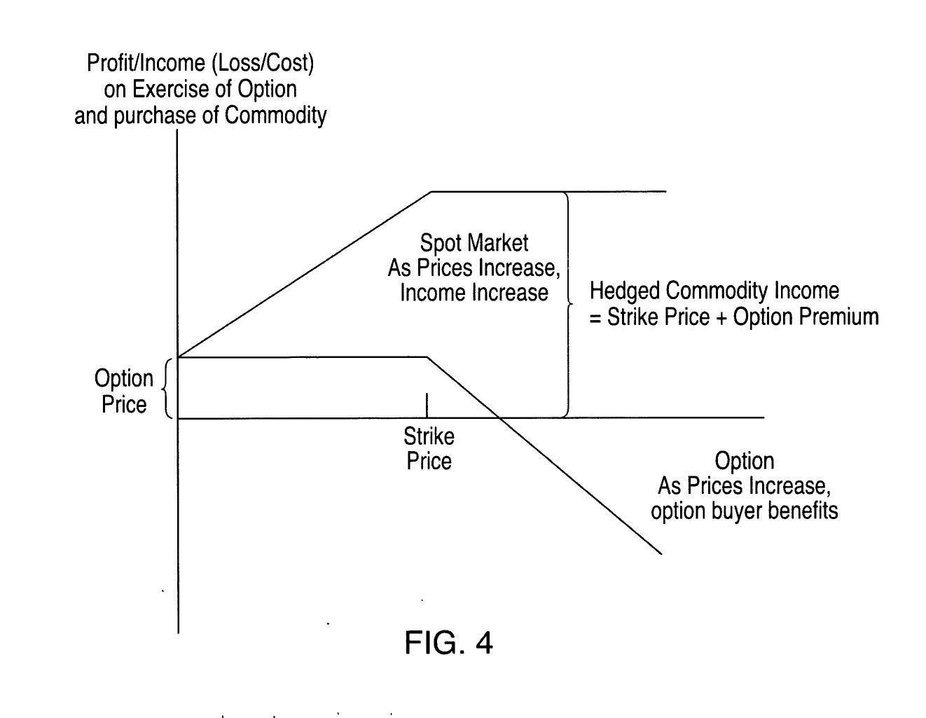

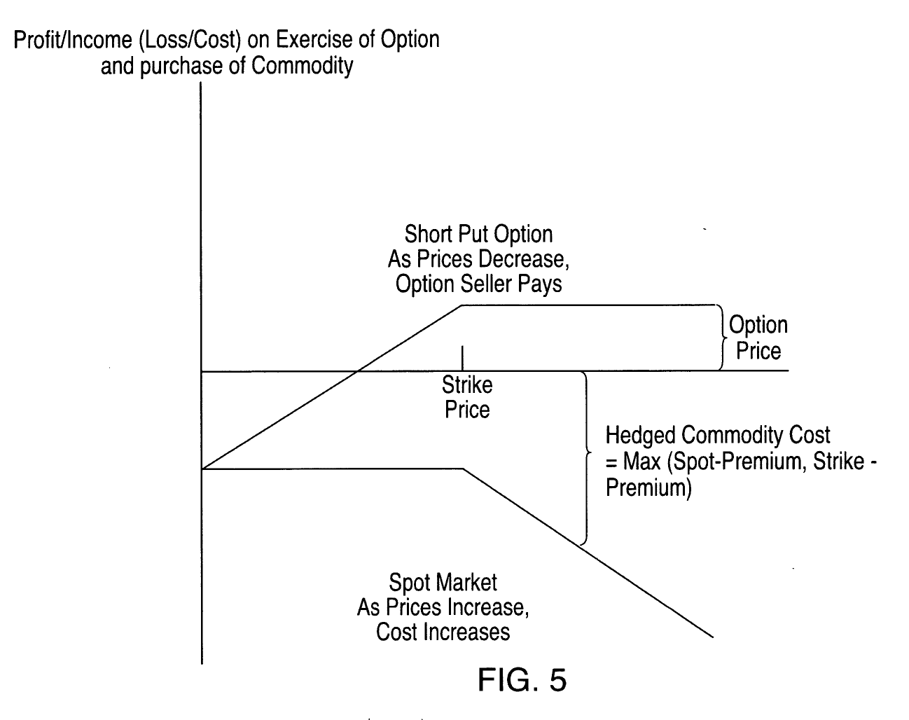

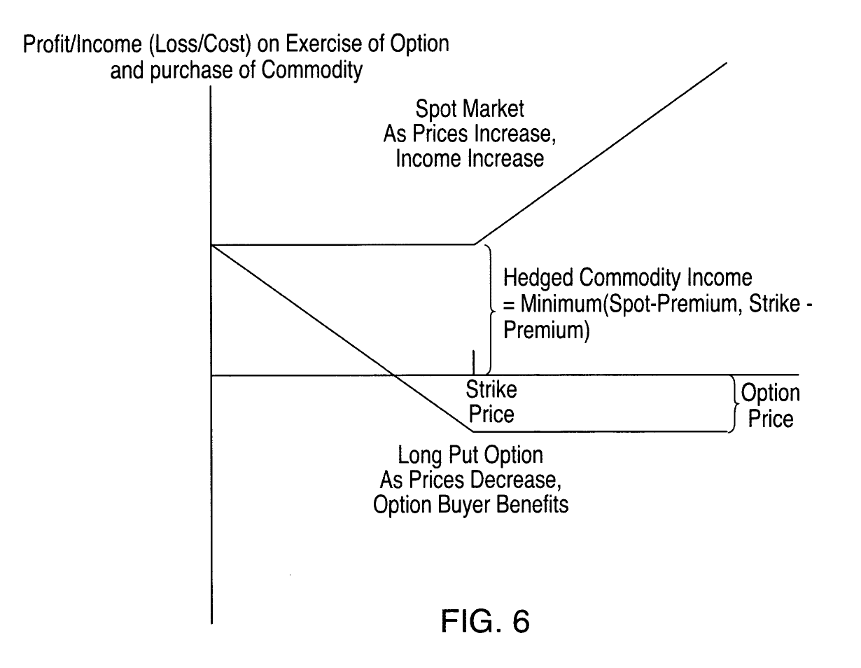

### DETAILED DESCRIPTION OF THE PREFERRED EMBODIMENTS

The present invention relates to a method of and system for clearing the marked value of different types of option contracts via a central counterparty. The method and system involves the contractual exchange of returns determined by an option pricing model, Option Model Swaps (OM Swaps). An OM Call swap is a swap of payments based on the output of a call valuation model; an OM Put swap is a swap of payments based on the output of a put valuation model. For ease of reference, common terms specifically related to the present invention will include a “VMAC” reference to distinguish them from existing products.

The value of a VMAC OM Call Swap is marked based on the output of the indicated pricing model. The present invention provides swaps based on a modified Black '76 model and an agreed upon price index. The Black '76 model is simply a Black-Scholes model swap designed to recognize the lack of carrying cost for an option on a futures contract or swap contract. If desired the system can be configured to operate with other pricing models.

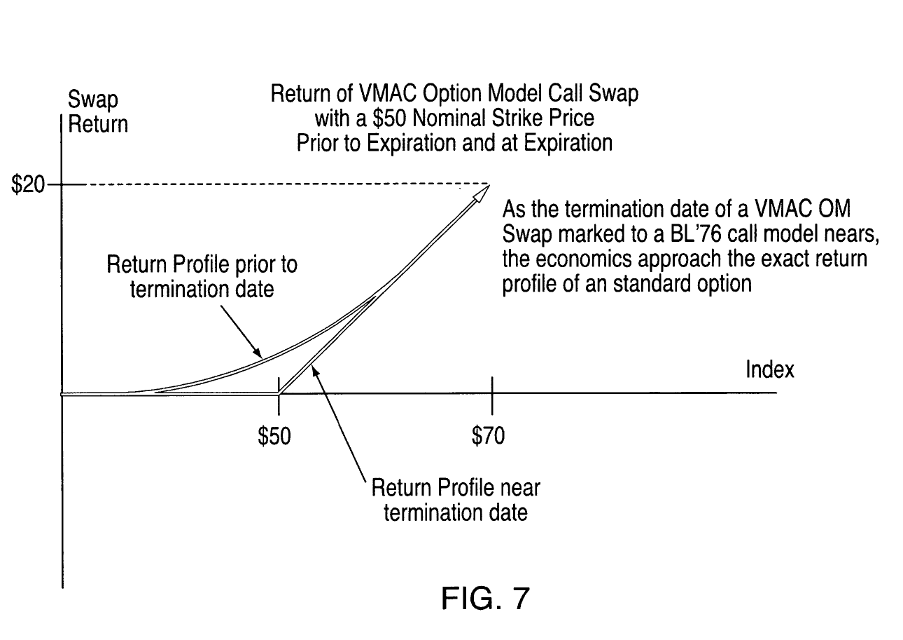

A VMAC OM Swap model output varies based on the model input. As an example, the Black '76 model is driven by underlying price (S), nominal strike price (K), risk free interest rate (r), volatility of the underlying asset price (a) and finally, the time to expiration (t). The graph in FIG. 7 shows movements in model valuation based on changes in underlying price S, for a specific swap (where K, σ and r are fixed for the life of the swap); over time the valuation will change even if the underlying price S remains constant. For every dollar change in the VMAC Option Model (OM) Index (ie—theoretical change in the value of an option), one dollar of value changes hands in the VMAC OM Swap. VMAC OM Swaps settle daily, so that daily changes in the OM index result in daily cash settlements in the VMAC OM Swaps.

As indicated above, the OM index inputs K, a and r may be held constant for a VMAC OM Swap, meaning that the OM index will change with respect to time, and to Price (S).

The return on an OM swap is non-linear with respect to changes in underlying price or index, and the returns to an OM Swap fixed payor and fixed receiver are asymmetrical with respect to changes in underlying price or index. The OM Fixed Payor has a much greater chance to make money than the Fixed Receiver (in fact, the fixed receiver has only loss probability, and no probability of gain if the swap is held through termination); therefore, the fixed receiver will only enter into such a swap if he receives compensation for the risk of incurring a such a loss. Option pricing models can be used to determine this premium.

The initial VMAC OM Call Swap price mark for a fixed receiver is: (Premiumₜ−Pₜ₊₁); subsequent daily marks will be (Pₜ₊ₙ−Pₜ₊ₙ₊₁). If the swap terminates with the price index less than the nominal strike, Pₜ₊₁ goes to zero and the Premium is fully earned. Similarly, if the swap terminates with the price index above the nominal strike, the net loss (if any) to the fixed receiver will include the fee income earned on the swap over the life thereof. (This is analogous to earning a premium over the life of an option).

The present invention is directed to methods of structuring OM swaps to achieve exactly the economics of 1) an option on a swap; 2) an option on physical delivery; and 3) an option on an index price at a given date and a system for operating VMAC OM Swaps.

Option on a Swap:

This is simply a VMAC OM Swap coupled with a swaption, giving the fixed payor of the OM swap (call or put) the option of entering into a swap at market with the fixed receiver of the OM Swap.

Option on a Physical:

This is a VMAC OM Swap coupled with a swaption on a Physical swap, giving the fixed payor of the OM swap (call or put) the option of entering into a Physical Swap at market; the Physical swap is accompanied by a bilateral indexed physical delivery contract.

Option on Index:

This is an VMAC OM Swap which settles nominal quantities on specific days against the Option Model calculated with respect to a specified index on such day. In accordance with the present invention there are amortizing OM Swaps, which settle daily quantities against the model output driven by the daily index, and remaining forward quantities settled against the model output driven by a forward index. Using OM Swaps in this fashion allows a Participant to clear the value of a cap or floor on a swap throughout the life of a contract.

Daily Cash Settlements and Netting:

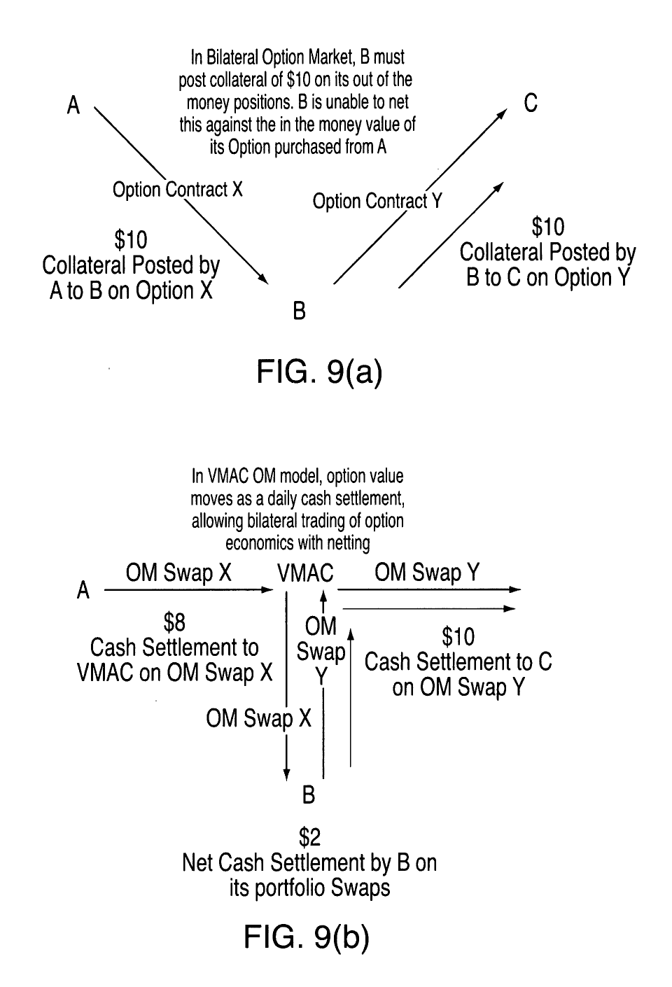

VMAC OM Swaps are unique in that they are marked to a value derived from market indices and an option pricing model and settled daily. In most bilateral markets, sellers of options or caps/floors have their positions marked to market and out of the money value is collateralized. This value is passed from one contract holder to the other contract holder in the form of a daily settlement. This allows holders of OM Swaps to net payments which would otherwise be trapped in bilateral collateral positions as shown in FIGS. 9(a) and 9(b).

The value of a VMAC OM Call Swap is marked based on the output of the indicated pricing model. VMAC can provide swaps based on a modified Black '76 model and an agreed upon price index. The Black '76 model is simply a Black-Scholes model swap designed to recognize the lack of carrying cost for an option on a futures contract or swap contract.

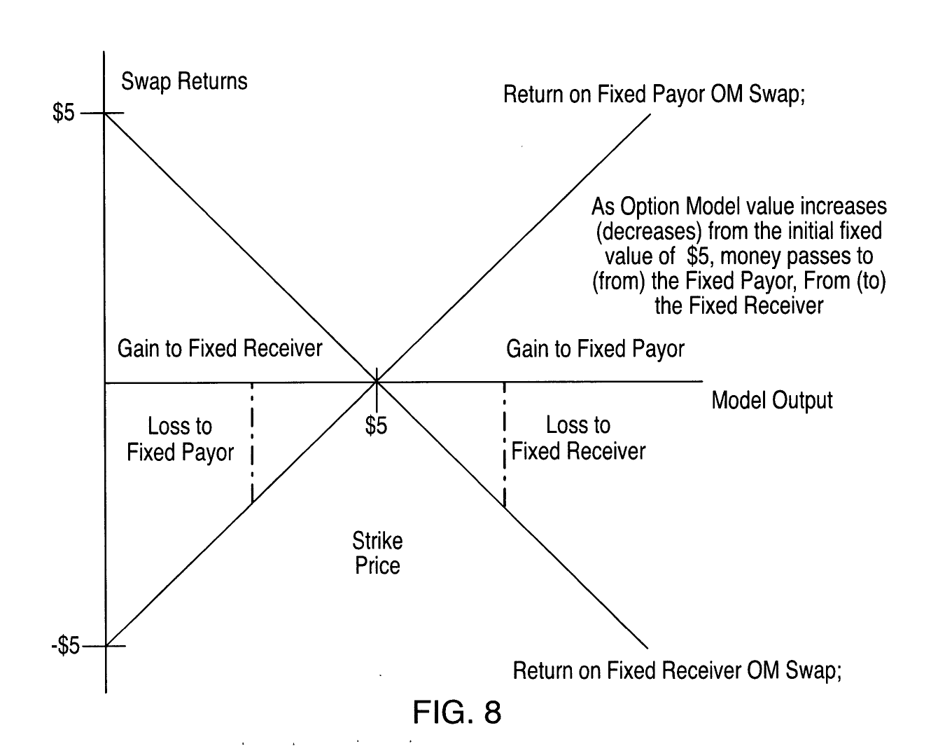

VMAC OM Swap model outputs vary based on the model input. As an example, the Black '76 model is driven by underlying price (S), nominal strike price (K), risk free interest rate (r), volatility of the underlying asset price (σ) and finally, the time to expiration (t). The graph in FIG. 7 shows movements in model valuation based on changes in underlying price S, for a specific swap (where K, σ and r are fixed for the life of the swap); over time the valuation will change even if the underlying price S remains constant. FIG. 8 shows how the value of a VMAC OM Fixed Payor and Fixed Receivor Swaps change with changes in the value of the VMAC Option Model Model Output.

For every dollar change in the Option Model (OM) Index (ie—theoretical change in the value of an option), one dollar of value changes hands in the VMAC OM Swap. VMAC OM Swaps settle daily, so that daily changes in the OM index result in daily cash settlements in the VMAC OM Swaps.

As indicated above, the OM index inputs K, σ and r may be held constant for a VMAC OM Swap, meaning that the OM index will change with respect to time, and to Price (S). The two curves shown in FIG. 7 show the index output over a range of Prices (S) and at two distinct times of valuation (ie—time to expiration). For the time period prior to termination date there is a variation between the valuation according to the model and the difference between Price (S) and the Share Price. However, as the time approaches the termination date the output follows the difference between market price and strike price closely.

Initial Marks

As shown in FIG. 7, the return on an OM swap is non-linear with respect to changes in underlying price or index, and the returns to an OM Swap fixed payor and fixed receiver are asymmetrical with respect to changes in underlying price or index. The OM Fixed Payor has a much greater chance to make money than the Fixed Receiver (in fact, the fixed receiver has only loss probability, and no probability of gain if the swap is held through termination); therefore, the fixed receiver will only enter into such a swap if he receives compensation for the risk of incurring a such a loss. Option pricing models can be used to determine this premium.

The initial VMAC OM Call Swap price mark for a fixed receiver is: (Premiumₜ−Pₜ₊₁); subsequent daily marks will be (Pₜ₊ₙ−Pₜ₊ₙ₊₁). If the swap terminates with the price index less than the nominal strike, Pt+, goes to zero and the Premium is fully earned. Similarly, if the swap terminates with the price index above the nominal strike, the net loss (if any) to the fixed receiver will include the fee income earned on the swap over the life thereof. (This is analogous to earning a premium over the life of an option).

Daily Cash Settlements

It has been noted that capped or floored swaps mimic the economics of options at expiration. This section outlines the similarities and how the swaps must be structured to mimic a call or put, long or short, and how VMAC OM Swaps allow a Participant to track and clear value prior to expiration.

Floored Swaps analogous to Call Option

Long Call=Fixed Payor Swap with Floor at ‘Strike’ Price

Short Call=Fixed Receiver Swap with Floor at ‘Strike’ Price

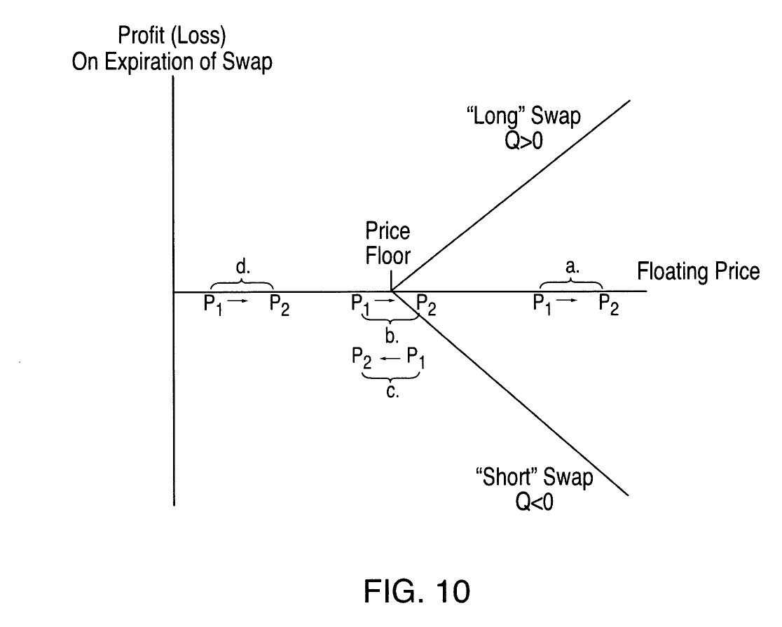

Daily Cash Settlements with Floor on Floating Price could be implemented as outlined in Table 1 below and as shown in FIG. 10, where P1 is the swap index on day 1, P2 is the swap index on day 2 and Ps is the floor price. Since VMAC swaps settle daily, the ‘floating’ price is considered to be P2, and P1 is the ‘fixed’ price.

TABLE 1
DCS for Floored Swaps in Various Market Conditions

| | Condition | Daily Cash Settlement |
|---|---|---|
| a | (P1 > Ps) AND (P2 > Ps) | Same as normal swap |
| b | P1 < Ps < P2 | DCS = (P2 − Ps) |
| c | P2 < Ps < P1 | DCS = (Ps − P1) |
| d | (P1 < Ps) AND (P2 < Ps) | DCS = 0 |

Capped Swaps analogous to Put Option

Long Put=Fixed Receiver Swap with a Cap at ‘Strike’ Price

Short Put=Fixed Payor Swap with at Cap at ‘Strike’ Price

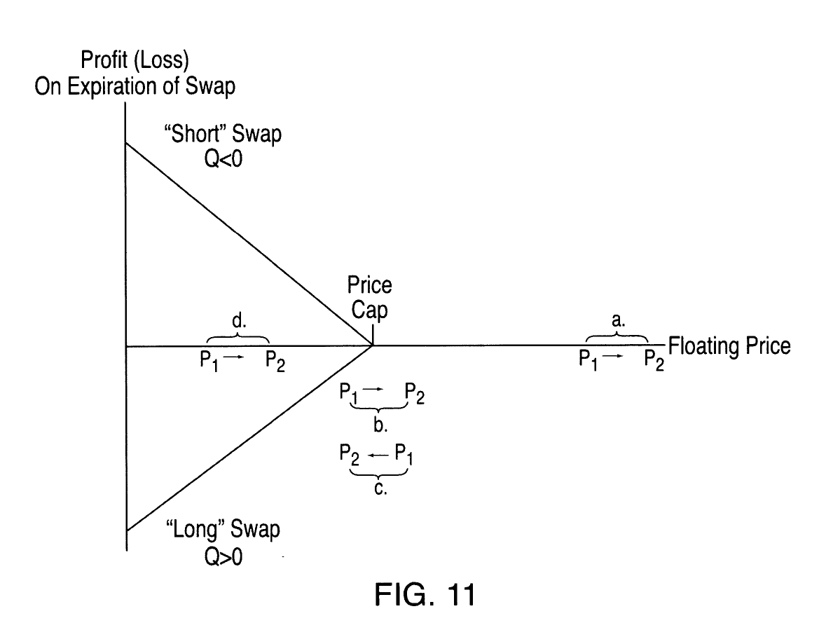

Daily Cash Settlements with a Cap on Floating Price could be implemented as outlined in Table 2 and as shown in FIG. 11 where P1 is the swap index on day 1, P2 is the swap index on day 2 and Ps is the cap or floor price. Since VMAC swaps settle daily, the ‘floating’ price is considered to be P2, and P1 is the ‘fixed’ price.

TABLE 2
DCS for Capped Swaps under Various Market Conditions

| | Condition | Daily Cash Settlement |
|---|---|---|
| A | (P1 > Ps) AND (P2 > Ps) | DCS = 0 |
| B | P1 < Ps < P2 | DCS = (Ps − P1) |
| C | P1 > Ps > P2 | DCS = (P2 − Ps) |
| D | (P1 < Ps) AND (P2 < Ps) | Same as normal Swap |

Cash Settlements using VMAC OM Swap Index

The settlement technique of the present invention does not capture the actual value of the swaption or capped/floored swap prior to expiration. Prior to expiration, the dollar value of an option or Cap or Floor on an index is dependent on the underlying index and time to expiration (as well as volatility, risk free interest rate and strike/cap/floor level), and can be measured by an option pricing model.

By structuring a swap which settles to a Black '76 model (or other standard option pricing model), the option value is captured across time and price (and changes in volatility and risk-free rate if tracked) and a single DCS model can apply to all pricing conditions throughout the life of the swap.

TABLE 3
Price Conditions and Daily Cash Settlement for a capped swap is

| | Condition | Daily Cash Settlement |
|---|---|---|
| A | (P1 > Ps) AND (P2 > Ps) | BSₚ₂ − BSₚ₁ |
| B | P1 < Ps < P2 | Where: |
| C | P1 > Ps > P2 | BS₂ is the put model price at time 2; and |
| D | (P1 < Ps) AND (P2 < Ps) | BS₁ is the put model price at time 1 |

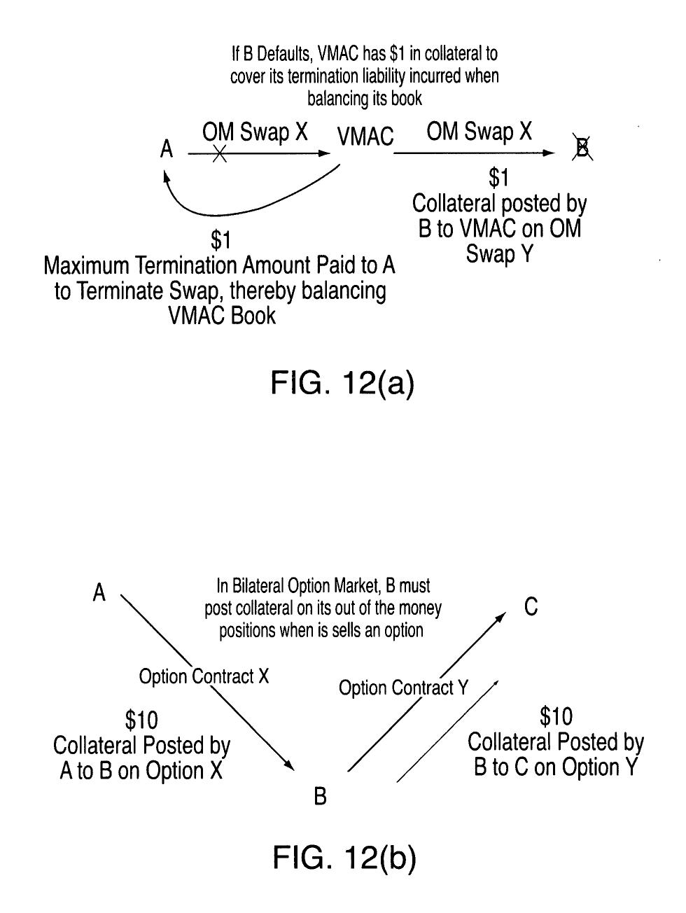

FIG. 7 shows how the return of a VMAC swaption swap marked to the BL '76 price index approaches that of an option near termination. This varies from the curve representing return prior to the termination date. The present invention is able to implement the clearing of marks to markets for illiquid OM Swaps by providing a central counterparty to all transactions conducted under the present invention; all credit and market risk is avoided, because of the programmatic call features imbedded in each swap. The system will only enter into Pairs of swaps. Therefore any swap portfolio is always fully balanced as shown in FIGS. 12(a) and (b). In the event of a default by one of the participants, the system maintains the right to terminate the corresponding non-defaulting participant in exchange for a payment which is capped at a Maximum Termination Amount for the related product. This payment is designed to compensate the holder of the terminated swap for moves in the market value of the swap from the time the swap was last settled to a later time when the holder of the terminated swap should have calculated his market losses (if any) from losing the terminated swap. The calculation of the Maximum Termination Amount is made using an algorithm which takes into account volatility, Strike/cap/floor price, holding period and confidence interval, among other attributes as shown in FIG. 12.

Termination Amounts for VMAC Option Model Swaps

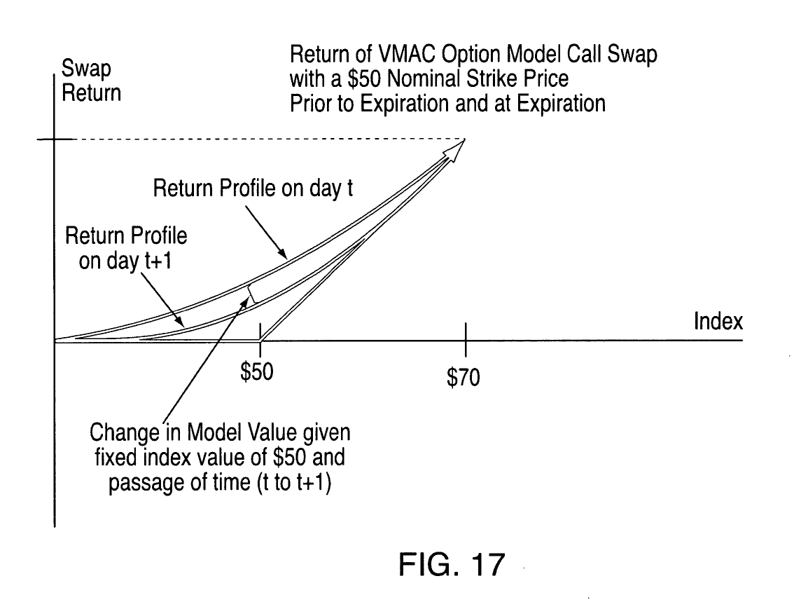

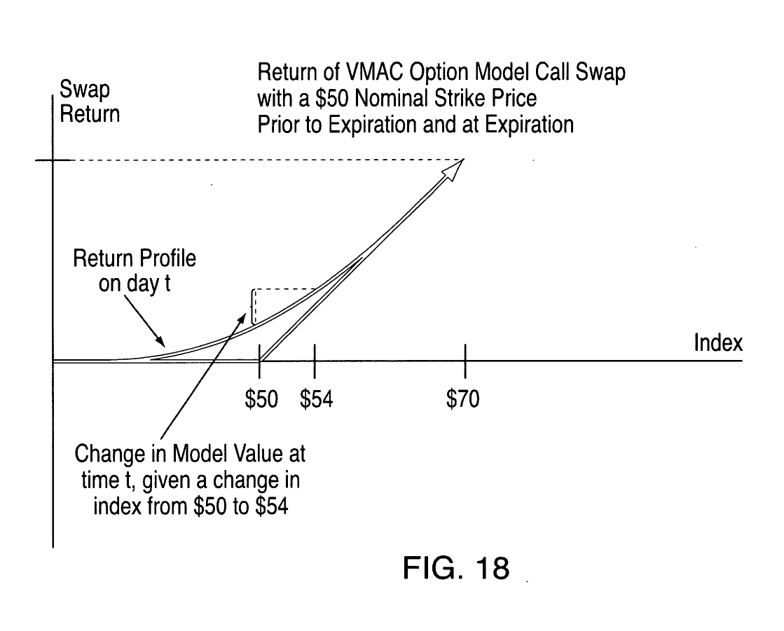

For a swap which settles to an index daily, the system calculates a Maximum Termination Amount as a function-of the volatility of the index (ie—the underlying index would be expected statistically to move a defined interval within a defined confidence interval). This potential movement is often referred to as value at risk or VAR. For an OM Swap, the value of the swap index can be expected to change a defined interval if the underlying index changes a defined interval and with the passage of time (effectively a defined change in the time to expiration) as shown in FIGS. 17 and 18. The VAR of an OM Swap (i.e. the expected change in value of an option model output given a change in one or more variables of the model) is in the greatest part driven by expected changes in the underlying index over a defined confidence interval; therefore, the Maximum Termination Amount (also known as Value at Risk, or “VAR”) is calculated on an OM Swap by taking the expected rate of change in the model output for a defined range of changes in the index. The rate of change of an option model with respect to index price is called the “delta”, and is the first derivative of the model with respect to the index. Because the system tracks the potential changes of many indices over defined ranges, it is a simple matter to apply this first derivative “delta” in calculating what the potential range of changes in output of the OM Swap would be.

The OM Swap VAR=Index Swap VAR*OM Swap “delta”. The OM Swap “delta” is the first derivative of the VMAC OM Swap Model with respect to index price, and indicates the rate of change in the model output, given a change in the underlying index. Given an estimation of volatility in the underlying index, a Value at Risk estimate can be made with respect to the index, and this can be used to estimate the VAR of the OM swap based on such index

Termination of Swaps and Exercise of Swaptions: Default Scenario

The netting system of the present invention allows its participants to post lower collateral through a set of proprietary rules in terminating swaps and re-pairing swaps. In the event of a default, there is no risk to the company of replacing a contract to balance its book, because it retains rights to either terminate swaps outright or change the bases of swaps; both rights give the company the ability to balance its book without requiring contracting of new swaps in the marketplace.

Because OM Swaps have asymmetrical returns for Fixed Receivers and Fixed Payors, and because the return profile is non-linearly dependent on Price and nominal strike, the system includes a method of calls and swaptions for OM Swaps which are designed to 1) ensure that the book is balanced in the event of a default by a participant trading in OM Swaps, and 2) minimize the amount of collateral required to be posted for the trading of OM Swaps.

OM Swaps Which have the Same Underlying Index, and Different Nominal Strikes

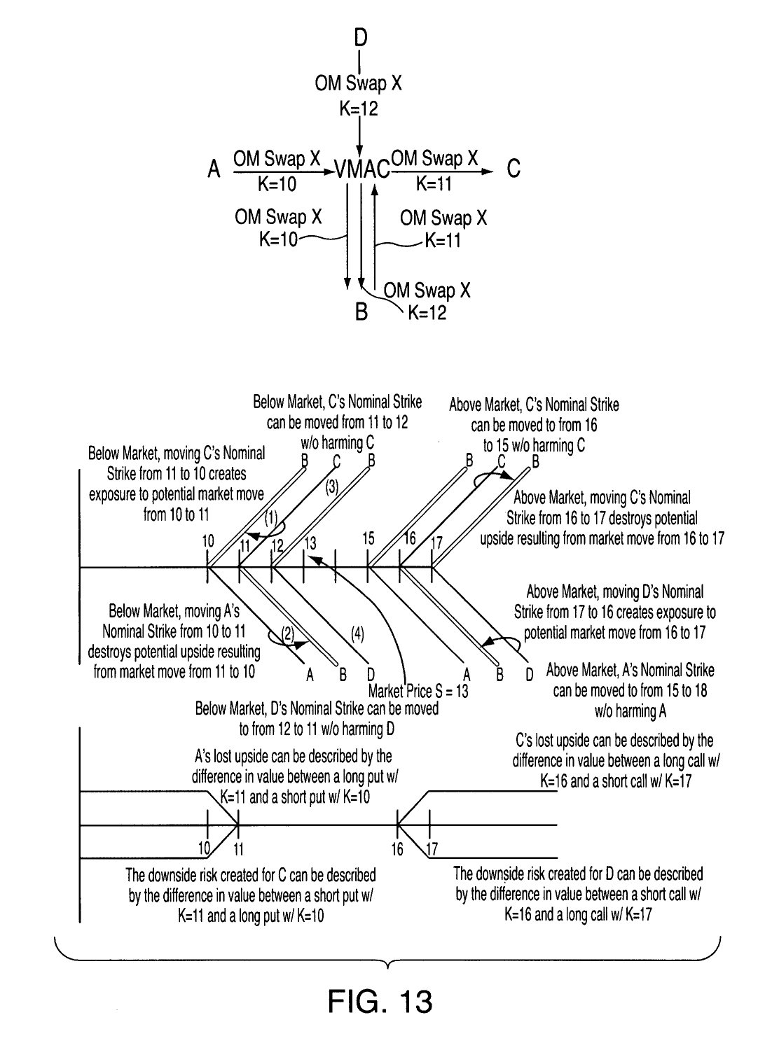

FIG. 13 shows how an example of a counterparty B, which has contracted three OM Swaps written on the same index, but at different nominal strike prices; long call at 10, long call at 12, and short call at 11. In order to minimize the collateral required from B while protecting the ability to terminate swaps or change the terms of swaps sufficiently to cover B's potential default, the clearing system in accordance with the present invention examines B's portfolio to determine which OM Swaps might be altered or called if B defaults.

In this example, the alternatives for terminating swaps or changing their terms are shown in FIG. 13. The options are to (1) change C's strike price from 11 to 10, (and terminate D outright); (2) change A's strike price from 10 to 11 (and terminate D outright); (3) change C's strike price from 11 to 12 (and terminate A outright); and (4) change D's strike price from 12 to 11, (and terminate A outright). In scenario (1), C would require compensation for the alteration in strike price, as the change creates additional risk of loss if prices fall below 11 through 10. Similarly, in scenario (2), changing A's strike price eliminates the possibility of a gain if prices fall between 11 and 10 and A would require compensation. On the other hand, no compensation would be required in either scenario (3) where potential loss for C between 12 and 11 is eliminated, or (4) where D is given additional probability of gain, similarly, if the strike prices in question were greater than the market price, optimal termination and strike price moves can be ascertained to minimize the value of lost upside or created risk.

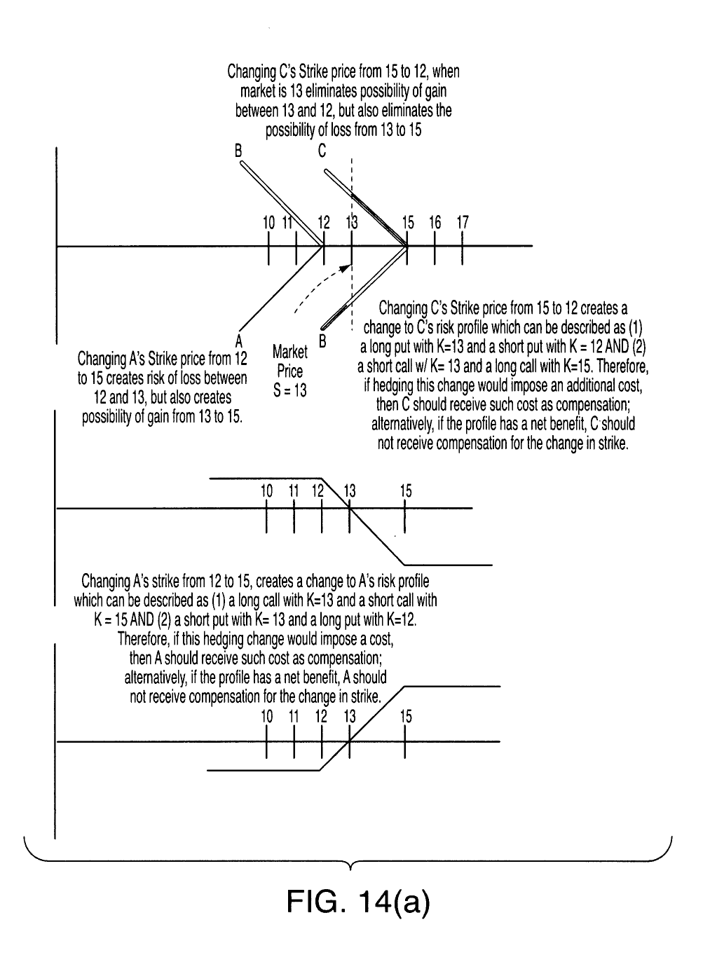

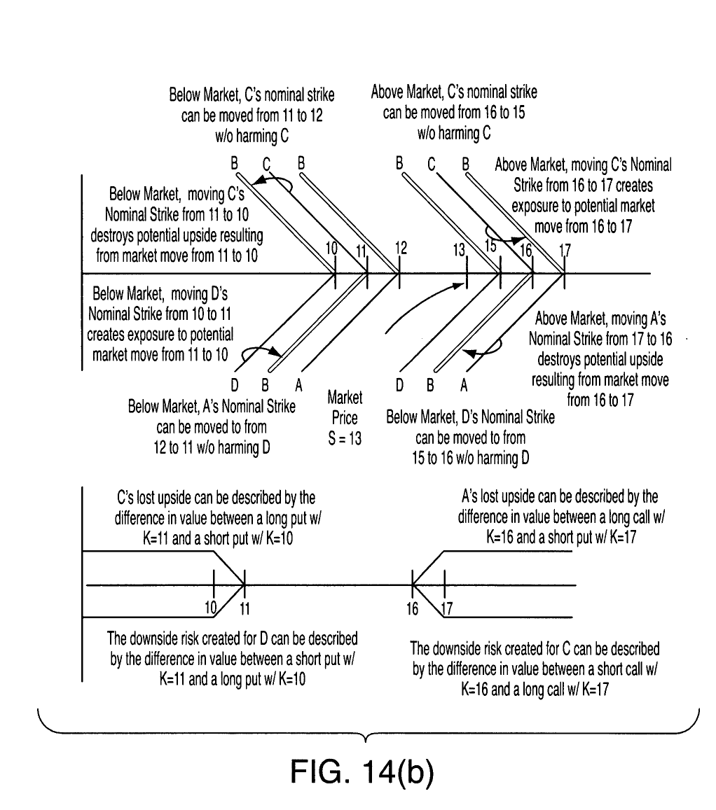

FIG. 14(a) shows how the method, in accordance with the present invention, determines terminations and strike price alterations and also applies it to VMAC OM Put swaps with different nominal strike prices.

Similarly, the present invention applies rules to determine if strike prices also can be changed economically to balance the VMAC clearing book when remaining swaps are initially written with strike prices on either side of the market price. FIG. 14(b) shows a scenario where a counterparty C may have its strike price changed from 15 to 12, when the market is at 13; alternatively counterparty A may have its strike changed from 12 to 15. The system of the present invention examines both alternatives and selects the least costly alternative; in addition, the method compares the least cost alternative with the alternative of simply terminating both swaps outright.

Table 4 below summarizes the rules for calculating the maximum termination amounts necessary when resetting the strike prices of OM Swaps which have the same underlying index, and different initial nominal strike prices; these rules apply to both OM Call and OM Put swaps. These maximum termination amounts are in turn used by the VMAC Clearing System in accordance with the invention to establish the collateral required by a counterparty (such as B) to ensure that in a default the VMAC Clearing System can either terminate the swap or re-pair them as appropriate under the rules on Table 4 without any exposure to the VMAC Clearing System and with minimal collateral required.

| | Terminated Paired | K1 < K2 | K2 < K1 |
|---|---|---|---|
| Strike | Swap Participant | New strike higher | New strike lower |
| Condition | Long or Short | than original | than original |
| K < S | Long (Fixed Payor) | 0 | Δ OM Put |
| K1 and K2 | | | valuation |
| both below | | | (K1, K2) |
| index | Short (Fixed Rec'r) | Δ OM Put | 0 |
| | | valuation | |
| | | (K1, K2) | |
| K > S | Long (Fixed Payor) | Δ OM Call | 0 |
| K1 and K2 | | valuation | |
| both above | | (K1, K2) | |
| index | Short (Fixed Rec'r) | 0 | Δ OM Call |
| | | | valuation |
| | | | (K1, K2) |

(Where K = Nominal Strike Price and S = Model Spot Price)
Note:
Table 4 shows payouts to non-defaulting parties; the references to longs/shorts in the later discussions will be with respect to the analyzed party, the potential defaulting party (generally represented as “B” in the diagrams herein).

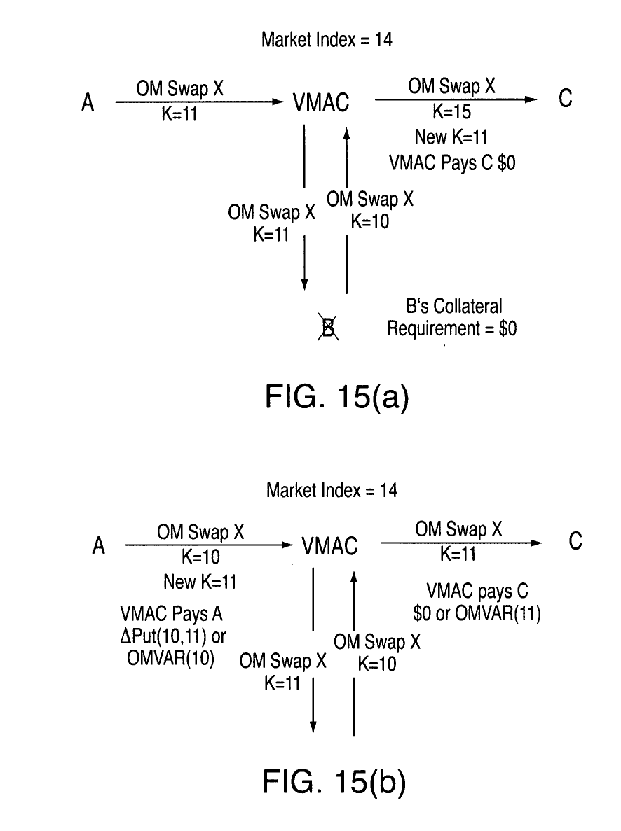

The re-pairing scenario affects the required collateral of a counterparty to VMAC Swaps; therefore, the system runs algorithms which determines the most efficient re-pairing configuration, thereby reducing collateral requirements for Participants. FIGS. 15(a) and 15(b) show how collateral requirements are reduced by potentials for re-pairing. At the end of this re-pairing process for the portfolio of a given party, there may be many swaps which are re-matched in the A-C format, and there may be several swaps which were not re-matched, and in which B, the analyzed party, remains as a fixed payor or fixed receiver. These “B” swaps may be terminated by paying the paired swap participant its market replacement cost up to the VMAC OM VAR calculation, or they may be re-paired with an OM Swap which has a correlated underlying index.

Re-Pairing OM Swaps Which have Different, but Correlated Underlying Indices;

Once all OM swaps which have the same underlying index which may be re-paired are re-paired, the system next looks at correlated positions. OM Swaps can be correlated up to 100%. Generally correlations are applied in a range of 80% to 95%. This allows the system to potentially further reduce option collateral requirements. The system ranks all indices by volatility. The system first looks at the OM Swaps with the highest volatility rankings, and compares them to correlated positions with the next lowest volatility ranking. Any possible re-pairing would be done as described in the section above. If there are re-pairings as described above, the termination payment will contain a correlation adjustment to compensate for the change in basis. The correlation adjustment is:
[OMVAR(x)+OMVAR(y)]*(1−CF)
where,
OMVAR(x) is the VAR of the OM Swap on product x;
OMVAR(y) is the VAR of the OM Swap on product y; and
CF is the correlation factor for products x and y at the time of analysis.

This process is undertaken until there are no further correlated OM swaps which may be re-paired; remaining swaps are then terminated. The total calculated cost of the terminations and re-pairing is then recorded as the collateral requirement for the analyzed party (in our examples above, B).

Correlations Between OM Swaps and Index Swaps

While in the money, the return behavior of an OM Swap is nearly identical to that of a standard Index Swap. Therefore, the system will correlate OM Swaps and Index Swaps while certain conditions are met; these conditions may include 1) index correlation between the underlying index of the OM Swap and the index of the Index Swap; 2) time to expiration of the swaps; relationship between VAR of the index swap and the OM VAR of the OM Swap, etc.

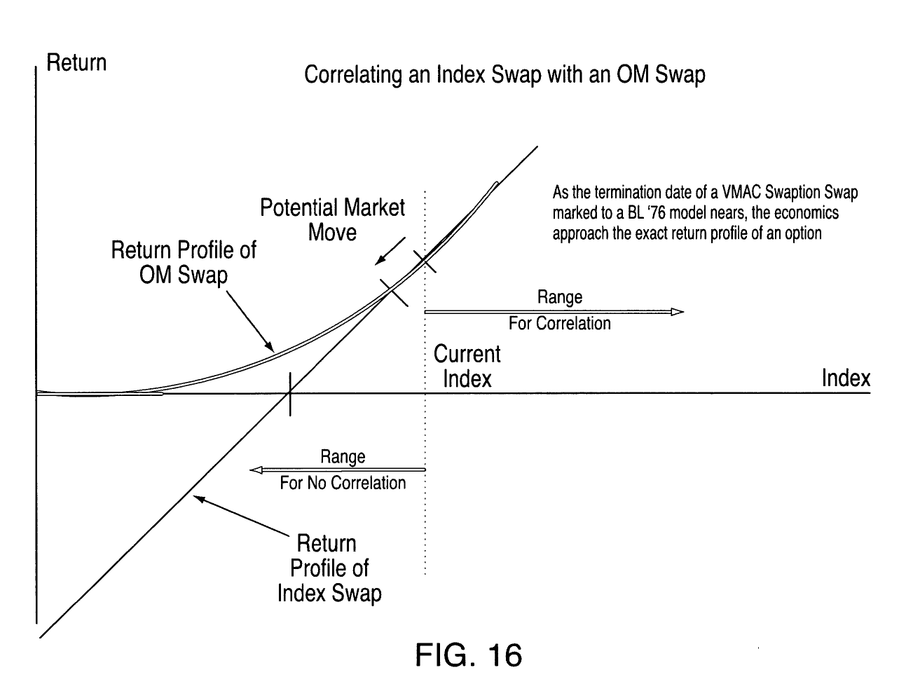

If the expected market moves of the OM and Index swaps are identical or closely correlated, then the system will correlate the two contracts. FIG. 16 shows the price range for which correlations would and would not exist for an index swap and an OM swap prior to termination; the system will not apply correlations if the value movement of the index swap and OM swap, given a move in the index, differ by more than 10 to 15%.

System Software

The software that analyzes the exchanging system in accordance with the present invention includes a series of algorithms and rules that are described in more detail bellow. The “front end” is the part of a software system that interacts directly with the user, and the “back end” comprises the components that process the output from the front end. The separation of software systems into “front ends” and “back ends” is an abstraction that serves to keep the different parts of the system separated.

Data Field

At the front end of the software system, Data Fields must accommodate the concept of the nominal strike price. The Premium of an OM Swap is analogous to the “contract” price of a standard swap. It is proposed that the Strike price be handled either in the name code, or added as an additional field.

Name Code
If adding as part of the name, the participants would have to code the name to include a nominal strike price. As an example, a service grid (for example PJM—Pennsylvania, Jersey, Maryland) September 07 OM swap with a nominal strike of 50.10 might be sent to the system a PJM_OM_CALL_Sept_{—}07_{—}50.10.
Designating a PJM West Hub, Option Model Call Swap, with termination at the end of September, 2007 and a nominal strike price of $50.10.

New Field

Alternatively, the front end can be modified such that the data entry includes a field to be completed by operator or API.

Allowable Strike Prices

In a preferred embodiment, Nominal Strike Prices should be allowed by the front end only in 10 cent increments. All other attempts should be rejected as bad data. Alternative increments can be implemented to meet market needs.

Defining Products

At the back end of the software system, each 10 cent increment Strike Price is considered a different product. Netting of positions will only occur (initially) among those products with the same hub/zone and strike prices.

Correlation Matrix Additions

As the system resets and re-clears each day, nightly, following the close of the markets, the correlation matrix will be updated with the following rules;

1. OM Swaps with Same Hub/Zone Index:

(a) If nominal strike 1<last hub index (this means the Platts Price for commodities involved, not Black 76 model output)<nominal strike 2 then Correlation=0
(b) For OM Swaps with Nominal Strikes<last index;
(i) If Long Strike>Short Strike; OM Correlation Factor=100%
The Liquidity Charge (LC) Calculated with a 100% of CF is $0. So we would always apply this logic if possible;
(ii) If Long Strike<Short Strike;
We wish to find a solution for CFom in which the required LC is in the form (1−CFom)*((δs+δl)*VARx);
Where δs*VARx is the OM Swap VAR for the short leg, and δl*VARx is the OM Swap VAR for the long leg.
Δshort (δₛ) is the “delta” of the short OM Swap;
Δlong (δₗ) is the “delta” of the long OM Swap;
The potential LC requirement is (ΔPutL−S) (see table 4 above);
It is important to note that if (ΔPutL−S)>(δs+δl)*VARx there is no advantage to using (ΔPutL−S) as the potential LC; the total LC would be lower using the sum of (δs+δl)*VARx (ie—rather than correlating, simply terminate both legs)
   So if (ΔPutL−S)>(δs30 δl)*VARx;
then CFom=0; else
we know that using our existing systems,
   (1−CFom)*(δs+δl)*VARx=(ΔPutL−S)
therefore:

$$CFom = 1 - \frac{ABS ( BSPutLong - BSPutShort )}{( δ short + δ long ) * VARx}$$
where:
BSPutLong=Black '76 Model for Put using Long position nominal strike;
BSPutShort=Black '76 Model for Put using Short Position nominal strike;
δshort is the “delta” of the short OM Swap;
δlong is the “delta” of the long OM Swap; and
VARx is the VAR calculation for a standard swap at the given Hub.
(c) For OM Swaps with Nominal Strikes>last mark;
(i) Long Strike<Short Strike; Correlation Factor=100%
(ii) Long Strike>Short Strike; Correlation Factor is

$$CFom = 1 - \frac{ABS ( BSCallLong - BSCallShort )}{( δ short + δ long ) * VARx}$$
where:
BSCallLong=Black '76 Model for Call using Long position nominal strike;
BSCallShort=Black '76 Model for Call using Short Position nominal strike;
Δshort (δₛ) is the “delta” of the short OM Swap;
Δlong (δₗ) is the “delta” of the long OM Swap; and
VARx is the VAR calculation for a standard swap at the given Hub.
   2. OM Swaps at Correlated Hubs

The method here is that the system will convert higher ranked (by volatility) OM swaps to lower ranked swaps. In the energy markets, volatility is highly correlated to liquidity. When a party has its swap converted to a new index the party will likely wish to trade out of the new product back into the old; therefore it is always desirable to give the party a more liquid instrument. When the system looks at OM Swaps X with volatility ranking of I and strike price of KX, and Y with volatility ranking of 2 and strike price of KY, the system needs to create a new potential nominal strike price for OM swap Y in order to see how that fits in with the above discussed logic.
(a) so that, from the Y swap, the system creates X′ with KX′=KY/SY*SX;
where SY is the index price of underlying hub Y (not the black '76 model output), and SX is the index price of underlying hub X.
(b) then picking up at 1 (a) above;
If nominal strike KX<last hub index (not Black 76 model)<KX′ then Correlation=0
(c) And for OM Swaps with Nominal Strikes KX AND KX′<last index;
(i) If Long Strike>Short Strike;
Again, the system seeks to find a solution for CFom in the form of (1−CFom)*((δs+δl)*VARx)
The system knows that the required LC is potentially equal to:
   (1−CFs)*(VARomx+VARomy);
where
CFs=the Correlation Factor for standard Swaps on X and Y;
VARomx is the VAR for OM Swap on X=δX*VARx; and
VARomy is the VAR for OM Swap on Y=δY*VARy
Therefore, the OM Correlation Factor would be derived from the fact that:
   (1−CFom)*(δs+δl)*VARx=(1−CFs)*(VARomx+VARomy)
So that

$$CFom = 1 - \frac{( 1 - CFs ) * ( VARomx + Varomy )}{( δ s + δ l ) * VARx}$$
(ii) If Long Strike<Short Strike;
In this pricing condition the system knows that the required LC is potentially
   (ΔPutL−S)+(1−CFs)*(VARomx+VARomy);
It is important to note that if (ΔPutL−S)+(1−CFs)*(VARomx+VARomy))>(VARomx+VARomy); then there is no advantage to using (ΔPutL−S)+(1−CFs)*(VARomx+VARomy)) as the potential LC; the total LC would be lower using the sum of (VARomx+VARomy)
   So if (ΔPutL−S)+(1−CFs)*(VARomx+VARomy)>(δs+δl)*VARx;
then CFom=0; else
the system knows that using the existing systems,
   (1−CFom)*(δs+δl)*VARx=(ΔPutL−S)+(1−CFs)*(VARomx+VARomy);
therefore:

$$CFom = 1 - \frac{( ABS ( BSPutLong - BSPutShort ) + ( 1 - CFs ) * ( VARomx + VARomy ) )}{( δ s + δ l ) * VARx}$$
where:
BSPutLong=Black '76 Model for Put using Long position nominal strike;
BSPutShort=Black '76 Model for Put using Short Position nominal strike;
δs is the “delta” of the short OM Swap at hub x;
δl is the “delta” of the long OM Swap at hub x; and
VARx is the VAR calculation for a standard swap at the given Hub
VARomx is the VAR for the lower volatility option at hub x.
VARomy is the VAR for the higher volatility option at hub y
(d) For OM Swaps with Nominal Strikes KX AND KX′>last index;
(i) If Long Strike<Short Strike;
The system know that the required LC is potentially equal to:
   (1−CFs)*(VARomx+VARomy);
where:
CFs=the Correlation Factor for standard Swaps on X and Y;
VARomx is the VAR for OM Swap on X=δX*VARx; and
VARomy is the VAR for OM Swap on Y=δY*VARy
Therefore, the OM Correlation Factor would be derived from the fact that:
   (1−CFom)*(δs+δl)*VARx=(1−CFs)*(VARomx+VARomy)
So that

$$CFom = 1 - \frac{( 1 - CFs ) * ( VARomx + Varomy )}{( δ s + δ l ) * VARx}$$
(ii) If Long Strike>Short Strike;
The system knows that the required LC is potentially
   (ΔCallL−S)+(1−CFs)*(VARomx+VARomy);
It is important to note that if (66 CallL−S)+(1−CFs)*(VARomx+VARomy))>(VARomx+VARomy); then there is no advantage to using (ACallL−S)+(1−CFs)*(VARomx+VARomy)) as the potential LC; the total LC would be lower using the sum of (VARomx+VARomy)
   So if (ΔCallL−S)+(1−CFs)*(VARomx+VARomy)>(δs+δl)*VARx;
then CFom=0; else
the system knows that using our existing systems,
   (1−CFom)*(δs+δl)*VARx=(ΔCallL−S)+(1−CFs)*(VARomx+VARomy);
therefore

$$CFom = 1 - \frac{( ABS ( BSCallLong - BSCallShort ) + ( 1 - CFs ) * ( VARomx + VARomy ) )}{( δ s + δ l ) * VARx}$$
where:
BSCallLong=Black '76 Model for Call using Long position nominal strike;
BSCallShort=Black '76 Model for Call using Short Position nominal strike;
δs is the “delta” of the short OM Swap at hub x;
δl is the “delta” of the long OM Swap at hub x; and
VARx is the VAR calculation for a standard swap at the given Hub
VARomx is the VAR for the lower vol option at hub x.
VARomy is the VAR for the higher vol option at hub y

Calculating Settlement Prices for OM Swaps

OM Swaps settle to a price output of a Black '76 model, which is a Black Scholes model modified to reflect the fact that there is no cost of carry for a futures contract or swap contract.

1. The Black '76 model output is

(a) For an OM Call Swap C=e^{-rt}[fΦ(d₁)−xΦ(d₂)]
(b) For an OM Put Swap P=e^{-rt}[xΦ(−d₂)−fΦ(−d₁)]
where:

$${d}_{1} = \frac{ln ( f / x ) + ( {σ}^{2} / 2 ) t}{σ \sqrt{t}}$$

$${d}_{2} = d 1 - σ \sqrt{t}$$
and:
f=current underlying forward price (ie the index price used in a standard swap;
x=the nominal strike price as defined in the OM Swap
r=the continuously compounded risk free rate (this should be an input value applicable to all OM Swap calculations. The system is able to change it freely.
t=the time in years until the expiration of the swap
σ=the volatility applicable to the indicated hub (ie if using price “f”, the volatility associated with that price hub).
Φ=the standard normal cumulative distribution function.
An OM Swap with identifier of PJM_OM_CALL_Sept_{—}07_{—}50.00 would be settled each day to the output of the Call model above, with f=PJM Price; x=$50.00; t=(Sep. 30, 2007−calculate)/365; σ=PJM Group Volatility.
This would apply for all dates except for the last day, when
If x>f
   C=f−x;
   P=0
And if f>x
   C=0; and
   P=x−f

2. Applying Settlements

The systems can be modified to do one of the following:
(a) Record each OM output daily as the price for each swap. This has the benefit of mirroring existing operational steps exactly. or
(b) Calculate the OM output at the time settlements are calculated, pulling the base hub price as an input to the Option Model. This has the benefit of not storing and retrieving what will be numerous different prices (remember that PJM_OM_CALL_Sept_{—}07_{—}50.00 is a different product that PJM_OM_CALL_Sept_{—}07_{—}50.10 and each will have a different OM output).

Calculating LC's

The LC's for a product reflect the potential change in value of the asset in question given a change in underlying price over a two day holding period and a 95% confidence interval. For a standard VMAC swap, this is the potential price move itself, while for an OM Swap this is the move in the OM model given a potential move in the underlying hub/zone index.

1. Calculations

Therefore the LC is simply the potential change in model output given a potential change in the underlying price (such potential price change being VARs, or standard swap VAR). The potential change in the model is the first derivative of the model with respect to underlying price, or the “delta” of the Black 76 model:
delta=δ=e^{-rt}Φ(d₁).
Therefore the LC of OM swap on index (hub or zone) z is
VARomz=δ_{z}*VAR_{z}
Where δz is the delta of OM Swap z, and VARz is the standard swap VAR for index z.

2. Applying the LC Calculations

The systems can be modified to do one of the following:

(a) Record each LC output daily as the LC for each OM swap. This has the benefit of mirroring existing operational steps exactly. or

(b) Calculate the OM LC output at the time LC outputs are required (for netting purposes, for feeding table to front end etc.), pulling the base hub price as an input to the Option delta Model.

As shown and described above, the system, in accordance with the present invention, clears the marked value of different types of option contracts via a central counterparty. The system determines the contractual exchange of returns by an option pricing model, Option Model Swaps (OM Swaps). An OM Call swap is a swap of payments based on the output of a call valuation model; an OM Put swap is a swap of payments based on the output of a put-valuation model. The system then provides swaps based on a modified Black '76 model and an agreed upon price index. The Black '76 model is simply a Black-Scholes model swap designed to recognize the lack of carrying cost for an option on a futures contract or swap contract. The system provides an option on a swap, an option on a physical or an option on index. In addition, the system conducts daily cash settlements and netting to allow holders of OM Swaps to net payments which would otherwise be trapped in bilateral collateral positions.

It will thus be seen that the objects set forth above, among those made apparent in the preceding description, are efficiently obtained and, since certain changes may be made in the above constructions without departing from the spirit and scope of the invention, it is intended that all matter contained in the above description or shown in the accompanying drawings shall be interpreted as illustrative, and not in a limiting sense.

It is also to be understood that the following claims are intended to cover all of the generic and specific features of the invention, herein described and all statements of the scope of the invention which, as a matter of language, might be said to fall there between.

What is claimed is:

1. A method of contracting between two counterparties with a central counterparty for the exchange of payments based on pairs of contracts, each contract having an initial price operated by the counterparty comprising:
calculating the cost to re-pair or terminate contracts in the event of a default by one of the counterparties to maintain a balanced book by the central counterparty;
receiving collateral from each counterparty equal to the total cost of the central counterparty to re-pair or terminate each of the counterparty's contracts if that counterparty were to default, the collateral being held by the central counterparty to satisfy the termination and re-paring payments in the event of a default by a counterparty;
minimizing the amount of collateral required from each counterparty by re-pairing or terminating contracts in an optimized fashion;
basing the exchange of payments upon the output of an option pricing model;
calculating the exchange of payments as the difference between the initial price and the model output;
calculating the model output periodically; and
exchanging the payments periodically.

2. The method of claim 1 further including calculating the value of the contracts and exchanging payments at the end of each business day.

3. The method of claim 1 wherein the calculating includes applying an option pricing model driven by at least one of the following variables: (i) an index indicating the price of a commodity; (ii) the volatility of the index; (iii) a nominal strike price; (iv) time to expiration; and (v) risk free interest rate.

4. The method of claim 3 wherein the receiving of collateral by the central counterparty to maintain a balanced book is performed by altering the variables for determining the option model output in the contract for exchanges of payments with another counterparty.

5. The method of claim 1 further including calculating a termination payment for balancing the book by the central counterparty.

6. The method of claim 4 wherein the variable altered is the strike price.

7. The method of claim 4 wherein the variable altered is the index.

8. The method of claim 6 further comprising:
determining which contract strike price to alter by analysis of the potential impact on each subject contract of proposed alteration of terms; and
selecting the contract which is least impacted by the alteration, as measured by minimizing an increased possibility of loss or a decreased possibility of gain.

9. The method of claim 7 further comprising:
determining which contract index to alter by analysis of the potential impact on each subject contract of proposed alteration of terms; and
selecting the contract which is least impacted by the alteration, as measured by minimizing an increased possibility of loss.

10. The method of claim 5 further including capping the termination at a maximum of the potential change in the model output given a predetermined range of possible moves in underlying index and a designated time interval.

11. The method of claim 10 wherein capping is set at an amount equal to an amount representing the potential movement in the model output over a range of changes in index prices and time intervals.

12. The method of claim 5 wherein calculating the termination payment includes analyzing:
the termination payment calculation applied to a contract with the initial index;
the termination payment calculation applied to a contract with the new index; and
an indicated correlation relationship between the two indices.

13. A central counterparty based trading system for exchanging payments based on pairs of contracts between two counterparties comprising:
a first counterparty with at least one trade having an initial price;
a second counterparty with at least one trade having an initial price and being paired to the first counterparty contract to maintain a balanced book by the central counterparty;
collateral received from each counterparty equal to the total costs of the central counterparty to re-pair or terminate each of the counterparty’ s contracts if that counterparty were to default, the collateral being held by the central counterparty to satisfy the termination and re-pairing payments in the event of a default by a counterparty
wherein the central counterparty re-pairs or terminates contracts in the event of a default by one of the counterparties to maintain a balanced book.
